(19) United States
(12) Patent Application Publication
(10) Pub. No.: US 2026/0369189 A1
(43) Pub. Date: Nov. 19, 2026

(54) MULTI-LAYER SIGNAGE CHANNEL LETTER WITH DYNAMIC VISUAL EFFECTS

(71) Applicant: Sikai Chen, Delran, NJ (US)

(72) Inventor: Sikai Chen, Delran, NJ (US)

(21) Appl. No.: 19/208,783

(22) Filed: May 15, 2025

(51) Int. Cl. G09F 13/04; G09F 13/00; G09F 13/06

(52) U.S. Cl. CPC G09F 13/0404; G09F 13/005; G09F 13/0445; G09F 13/06

(57) ABSTRACT

A multi-layer channel letter structure with a plurality of parallel facing layers, each internal layer featuring a unique design or image. One or more sets of LED lights are positioned along the edge of the layers to illuminate the respective layer. The face layer of the channel letter is made from color-changeable acrylic or vinyl, which alters its appearance depending on the viewing angle and lighting conditions. This design allows for a visually striking and customizable signage solution suitable for various commercial applications.

### FIELD OF THE INVENTION

The present invention relates to illuminated signage, specifically to signage channel letters that incorporate multiple layers, each layer displaying different designs or images, and utilizing LED lighting to create dynamic color-changing effects.

### BACKGROUND OF THE INVENTION

Traditional channel letters are commonly used in signage and are typically illuminated using LED strips placed within the letters' enclosure. However, existing designs often provide only uniform lighting without the ability to create depth, color-shifting effects, or dynamic visual transitions based on the viewer's angle. There is a need for an innovative channel letter structure that enhances visual appeal through layered design and strategically placed LED lighting.

### SUMMARY OF THE INVENTION

It is thus the object of the present invention to provide a multi-layer signage channel letters which address the need for innovative and visually dynamic, ever-changing, and exciting signage.

These and other objects are accomplished by the present invention, a multi-layered channel letter structure wherein each internal layer features a unique design or image. One or more sets of LED lights are positioned along the bottom of the layers to illuminate the respective layer. The face layer of the channel letter is made from color-changeable acrylic or vinyl, which alters its appearance depending on the viewing angle and lighting conditions. This design allows for a visually striking and customizable signage solution suitable for various commercial applications.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is an exploded front perspective view of the channel letter of the present invention showing the multiple internal layers and the components of the outer casing.

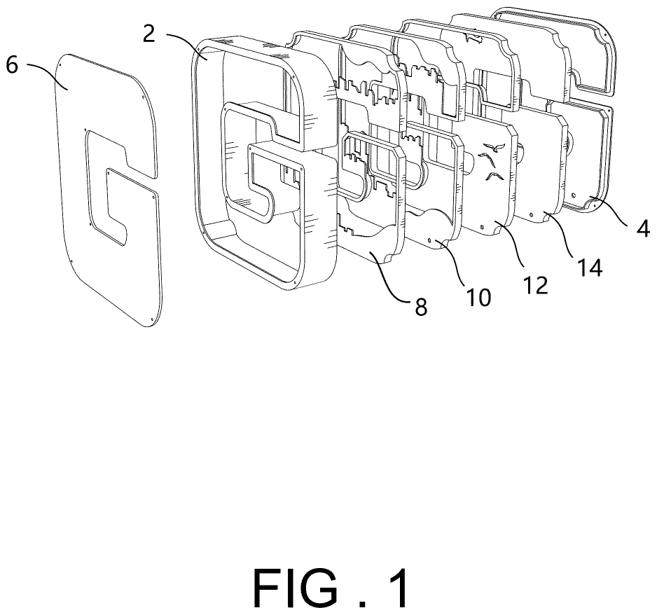

FIG. 2 is an exploded elevation view of the layers and outer casing of the channel letter of the present invention.

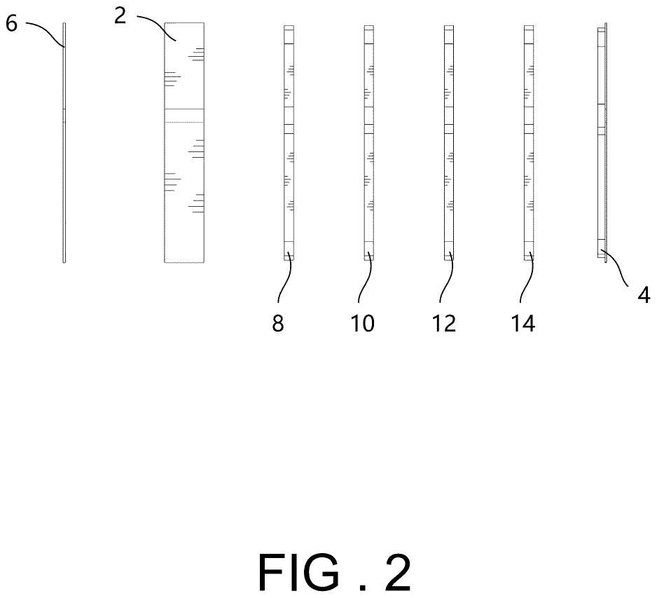

FIG. 3 is an exploded rear perspective view of the internal layers and the components of the outer casing of the channel letter of the present invention.

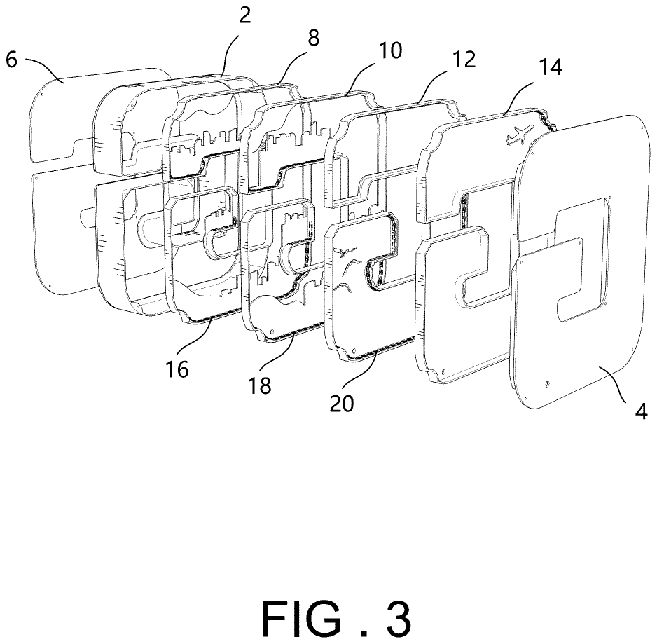

FIG. 4 is a perspective view of the channel letter of the present invention with its layers and outer casing assembled to form the complete channel letter.

### DETAILED DESCRIPTION OF THE INVENTION

The multi-layered signage channel letter of the present invention comprises a signage channel letter having signage channel letter outer casing 1 comprising front frame 2 and back panel 4. Translucent front facing layer 6 is aligned parallel to and is designed to attach to front frame 2. Front facing layer 6 is composed of a color changing material which visually modifies its appearance, depending on the type, color, and brightness of illumination through the facing layer and the angle at which it is viewed.

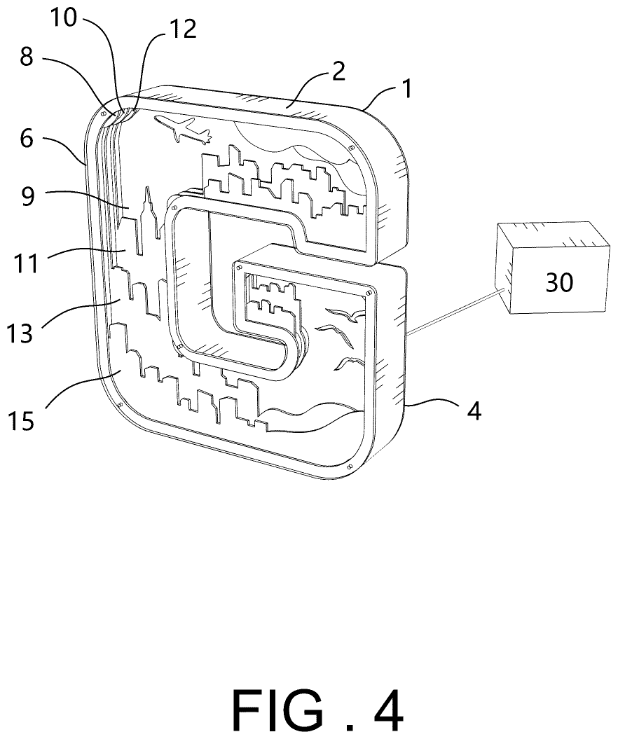

A plurality of separable, unattached translucent internal layers 8, 10, 12, and 14 are aligned parallel to front frame 2, front facing layer 6, and back panel 4. These internal layers remain unattached to each other. However, when they are aligned and are enclosed within outer casing 1 and the casing is attached to front facing layer 6, the internal layers are maintained and aligned within the outer casing, resulting in a channel letter which forms a compact unit, as seen in FIG. 4.

Each of the internal layers 8, 10, 12, and 14 has a distinct design image. By way of example only and not to be considered restricted to the design images disclosed herein, internal layers 8, 10, 12, and 14 each display different representations of city skylines 9, 11, 13, and 15, respectively.

Sets of LED lights 16, 18, and 20 are located along the bottom edges of and are attached to internal layers 8, 10, and 12, respectively. These can be single color or RGB in order to enhance visual transitions. The LED lights could also be located at the top edge or other desired edge of the layers.

Electrically operated control system 30 is connected to the signage channel letter to provide continued adjustment of such factors as the brightness, color and timing of the illumination and effects transmitted to the channel letter.

This innovative channel letter design enhances traditional signage by introducing layered depth, striking visual effects, dynamic lighting, and a color-shifting faceplate. The combination of these features results in a unique and customizable advertising tool for businesses and organizations seeking distinctive eye-catching signage.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A multi-layered signage channel letter comprising:
a signage channel letter outer casing comprising a front frame and a back panel aligned parallel to the front frame;
a translucent front facing layer aligned parallel, attached to, and enclosing the front frame of the outer casing;
a plurality of translucent internal layers aligned parallel to and located between the front frame and the back panel, each internal layer having a different and distinct design image, and
a plurality of LED lights located along the edges of the internal layers.

2. The multi-layered signage channel letter as in claim 1 wherein the front facing layer is composed of a color changing material which modifies its appearance, depending on the type of illumination and an individual's viewing angle.

3. The multi-layered signage channel layer as a claim 1 further comprising a control system for adjusting the brightness, color, and timing of the LED lights, thereby creating dynamic signage effects.
